(19) United States
(12) Patent Application Publication
(10) Pub. No.: US 2008/0041412 A1
(43) Pub. Date: Feb. 21, 2008

(54) LIGHTED DISPOSABLE FLOSSER HANDLE

(76) Inventors: John M. Jansheski, Maryville, TN (US); Lex Shankle, Maryville, TN (US); Eric Mowell, Maryville, TN (US)

Correspondence Address: LUEDEKA, NEELY & GRAHAM, P.C., P O BOX 1871, KNOXVILLE, TN, 37901, US

(21) Appl. No.: 11/465,596

(22) Filed: Aug. 18, 2006

(51) Int. Cl. A61C 15/00

(52) U.S. Cl. 132/322

(57) ABSTRACT

A reusable handle for use with a disposable dental flosser having an electrical circuit located within the handle for operating an illumination source to illuminate floss of the flosser and an area of interest during use of the flosser at the area of interest.

### FIELD

This invention relates to the field of dental flossing devices. More particularly, this invention relates to a reusable handle for use with a disposable flosser and featuring an illumination source configured to illuminate the floss of the disposable flosser during use at a site of interest.

### BACKGROUND

Improvement is desired in the construction of reusable handles for use with disposable flossers. What is desired is a reusable handle configured to illuminate the floss of the disposable flosser during use at a site of interest.

### SUMMARY

The above and other needs are met by a reusable handle for use with disposable flossers having floss.

In a preferred embodiment, the handle includes a receiver for receiving a portion of the disposable flosser, an illumination source, and an electrical circuit located substantially within the handle and being operable to enable illumination of the illumination source to illuminate the floss and the area of interest during use of the flosser at the area of interest.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is an upper perspective view of a handle for use with a disposable flosser according to a preferred embodiment of the disclosure.

FIG. 2 is an exploded view of the handle and flosser of FIG. 1.

FIG. 3 is a lower perspective view of a handle and flosser of FIG. 1.

FIG. 4 is an exploded view of the handle and flosser of FIG. 3.

FIG. 5 shows a portion of the handle of FIG. 1, with the flosser installed.

FIG. 6 is a side view of the handle portion of FIG. 5.

FIG. 7 is a schematic of an electrical circuit used in the handle of FIG. 1.

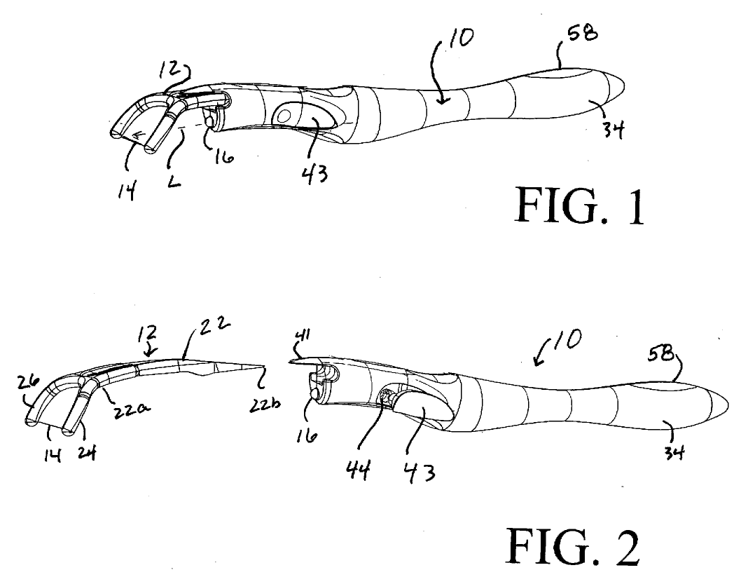

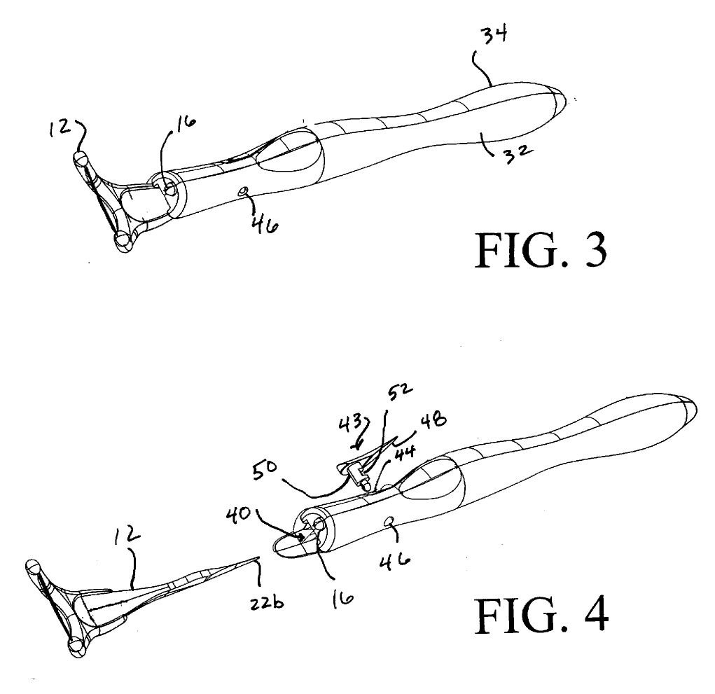

### DETAILED DESCRIPTION

With reference to the drawings, the disclosure relates to a reusable handle 10 for use with a disposable flosser 12 having floss 14. The handle 10 includes an illumination source 16 configured to direct light to the floss 12, as indicated by arrow L, to illuminate and enhance visibility of the floss 14 at sites of interest. An associated electrical circuit 18 operated by a switch 20 enables a user to selectively illuminate the illumination source 16.

The handle 10 advantageously receives and fixedly retains the disposable flosser 12 to facilitate use of the flosser 12. The illumination device 16 is advantageously configured to focus light at the floss 14, at the point of interaction of the flosser with the teeth or tooth of a user. Thus, a third party user or a user with the aid of a mirror may achieve improved visibility of the locations to be flossed or otherwise interacted with by the floss. For example, when attempting to dislodge a food particle or to inspect the location to be flossed, a user may, with the aid of a mirror, either handheld or mounted, more easily light and view the interaction of the floss with the tooth or gum. The used flosser 12 may be easily removed from the handle 10 for disposal and a new flosser 12 installed. The handle 10 is also advantageous to facilitate gripping and manipulation of the disposable flosser.

A preferred disposable flosser 12 is a disposable flosser available under the name EASY ANGLE from DenTek Oral Care, Inc. of Maryville, Tenn. Such a flosser 12 is described herein and includes a handle 22 and a pair of arms 24 and 26 extending from a distal end 22a of the handle 22. The floss 14 extends between the arms 24 and 26. The handle 22 of the flosser 12 has a length of about 2 inches and a decreasing taper from the distal end 22a to a proximal end 22b, which may serve as a pick when removed from the handle 10.

The handle 10 includes a housing 30 having a first housing member 32 and a second housing member 34, each of molded plastic construction and configured to mate together as halves of housing 30 of the handle 10 to receive the flosser 12 and house the illumination source 16 and the associated circuit 18. Portions of the exterior surfaces of the housing members 32 and 34 may preferably include overmolded portions made of an elastomeric material, such as thermoplastic elastomeric (TPE) resins, for aesthetics and to enhance gripping by a user. A variety of plastics of the type used to make thin-wall handles may be used to make the housing members 32 and 34, including flexible polyolefin plastics and the like.

The housing members 32 and 34 are configured to mate together, as by adhesive, friction fit, sonic welding, or the like to receive the handle 22 of the flosser 12, locate the illumination source 16 to direct light to the floss 14 of the flosser 12, and to house the circuit 18. The housing member 34 is similarly configured to the housing member 32, it being understood that the housing members 32 and 34 mate as halves. Accordingly, it will be understood that the construction of the housing member 32 described herein corresponds to the construction of the housing member 34.

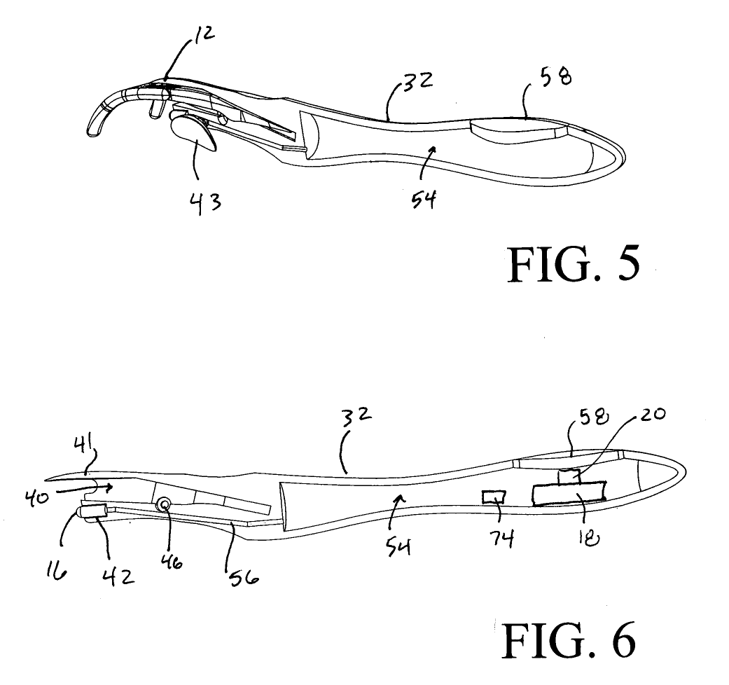

For example, with reference to FIGS. 5 and 6, the housing member 32 (and hence the housing 30) defines a receiver 40 configured for receiving the handle 22 of the flosser 12. For use with the depicted flosser 12, the upper distal portion of the handle 10 preferably includes an extension 41 configured to bear against the flosser 12 and stabilize the flosser against movement. The housing member 32 (and hence the housing 30) also includes a mount 42 for mounting of the illumination source 16 proximate to the flosser 12 so that light emitted from the illumination source 16 is directed to the floss 14 when the flosser 12 is received by the handle 10. To provide a close fit to help retain the flosser 12 within the receiver 40, and hence the handle 10, the receiver 40 is preferably a passage tapered to correspond to the taper of the handle 22 of the flosser 12, although it need not be and may be sized large enough to receive a variety of flosser handle shapes. The mount 42 may be provided as by a bore configured to receive and frictionally retain the illumination source 16.

The handle 30 preferably includes a retainer 43 manipulatable by a user. The retainer 43 is configured to retain the flosser 12 during use and to permit installation and removal of the flosser 12. For example, the retainer 43 may have a first dimension configured to engage the handle of the flosser and a second dimension configured to not engage the handle of the flosser. When the retainer is oriented with the first dimension adjacent the handle of the flosser, the flosser is frictionally retained within the receiver by the retainer. When the retainer 43 is oriented with the second dimension adjacent the handle of the flosser, the flosser is not frictionally retained by the retainer and the flosser may be installed or removed from the receiver.

For the purpose of example, in one embodiment the retainer 43 includes a distal end insertable through an aperture 44 in the sidewall of the housing member 32 and received by a corresponding aperture 46 in the sidewall of the housing member 34. The proximal end of the retainer 43 is configured as a stop 48 to rest against the exterior of the sidewall of the housing member 32 and a shaft 50 extending from the stop 48 is configured to bear against the handle 22 of the flosser 12 when the handle 22 is received in the receiver 40 to frictionally retain the handle 22 within the receiver 40. The shaft 50 also includes a groove 52 configured such that a user may grasp the stop 50 and rotate the retainer 43 to align the groove 52 with the handle 22 to permit the handle 22 to slide in the receiver 40 to permit installation or removal of the handle 22 of the flosser 12.

The housing 30 also defines a cavity 54 in which the circuit 18 may be located. To connect the illumination source 16 to the circuit 18, a conduit 56 is defined in the housing members 32 and 34 for passage of a wire or other electrical connector to place the illumination source 16 in electrical communication with the circuit 18. The switch 20 associated with the circuit 18 is preferably located adjacent a designated portion 58 of the housing 30 configured for engagement by a user to activate the switch 20 to turn the illumination source 16 on and off. For example, the designated portion 58 may include overmolding with TPE resin as previously described to identify the location of the switch 20. By depressing the designated portion 58, sufficient depression of the plastic material of the handle 10 at the designated portion 58 may be achieved to operate the switch 20. Alternatively, the switch may extend outside the surface of the handle 10, however, it is preferred that the handle 10 represent a substantially sealed structure so as to be unaffected as by rinsing with water and the like.

The illumination source 16 is preferably a light emitting diode configured and fixedly positioned, as by use of adhesive or a friction fit, within the mount 42, by operation of the switch 20 associated with the circuit 18, illuminating light directed to the floss 14 to light the area of interest. A preferred light emitting diode has a luminous intensity of about 1 candela.

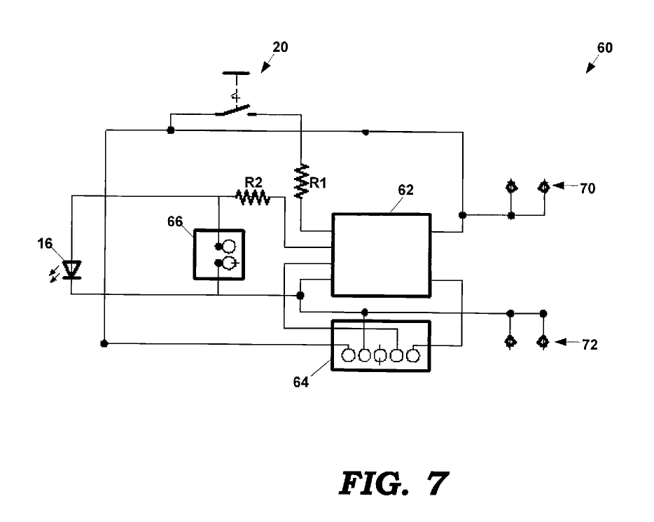

With reference to FIG. 7, there is shown a schematic of a preferred embodiment of an electrical circuit 60 for controlling activation of the illumination source 16. The circuit 60 includes a microprocessor controller 62, such as a “programmable system on a chip” (PSOC) having model number CY8C21123-24SXI manufactured by Cypress. The controller 62 enables use of a momentary dome switch device for the switch 20, such as part number F12340 manufactured by Snaptron. Not only does the controller 62 selectively activate the illumination source 16, but it also automatically shuts it off after a predetermined time to conserve battery power. In the preferred embodiment, the illumination source 16 is configured for illumination purposes and is preferably a white (visible) light LED, such as part number 67-1690-ND manufactured by Lumex, which is received in connection port 66. The circuit 60 may include a programming port 64 for programming the controller 62. Positive and negative battery terminals 70 and 72 are provided for connection of the one or more batteries 74. In a preferred embodiment of the circuit 60, the resistor R1 has a value of 50 KΩ, and the resistor R2 has a value of 50Ω.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A reusable handle for use with a disposable dental flosser of the type having a handle with a pair of arms having floss therebetween, comprising:
a handle having an illumination source and a receiver for receiving the handle of the disposable flosser; and
an electrical circuit located substantially within the handle and being operable to enable illumination of the illumination source to illuminate the floss and an area of interest during use of the flosser at the area of interest.

2. The handle of claim 1, wherein the handle includes first and second housing members of molded plastic construction.

3. The handle of claim 1, wherein an end of the handle defines a mount for mounting the illumination source.

4. The handle of claim 1, wherein the illumination source comprises a light emitting diode.

5. The handle of claim 1, wherein a distal exterior portion of the handle includes an extension configured to bear against the flosser and stabilize the flosser against movement.

6. The handle of claim 1, wherein the receiver comprises a passage and the handle further comprises a retainer for maintaining the handle of the disposable flosser within the receiver, the retainer comprising a shaft insertable through an aperture in a sidewall of the handle proximate the receiver and movably orientable, the shaft including a first dimension configured to engage the handle of the flosser and a second dimension configured as a groove to not engage the handle of the flosser, wherein when the shaft is oriented with the first dimension adjacent the handle of the flosser the flosser is frictionally retained within the receiver by the retainer and when the shaft is oriented with the groove of the second dimension adjacent and aligned with the handle of the flosser the flosser is not frictionally retained by the retainer and the flosser may be installed or removed from the receiver.

7-11. (canceled)
